(19) United States
(12) Patent Application Publication
(10) Pub. No.: US 2026/0277005 A1
(43) Pub. Date: Sep. 17, 2026

(54) HEAD-MOUNTED DISPLAY

(71) Applicant: CHENG UEI PRECISION INDUSTRY CO., LTD., New Taipei City (TW)

(72) Inventor: CHIN-CHUNG LIN, New Taipei City (TW)

(21) Appl. No.: 19/212,612

(22) Filed: May 19, 2025

(30) Foreign Application Priority Data
Nov. 29, 2024 (CN) 202422949335.X

(51) Int. Cl. G02B 27/01

(52) U.S. Cl. CPC G02B 27/0176; G02B 2027/0154; G02B 2027/0161

(57) ABSTRACT

A head-mounted display includes a housing including a bracket, at least one elastic fastener, at least one positioning part, a face mask, at least one positioning elasticity piece and at least one limiting element. The bracket is assembled to a rear of the housing. The at least one elastic fastener has an elastic arm extended rearward from a rear surface of the bracket. The at least one positioning part is protruded frontward from a front surface of the bracket. The face mask is detachably assembled to a rear of the bracket. The at least one positioning elasticity piece is disposed on an inner side wall of the face mask. The at least one limiting element is formed on a front surface of the face mask. The at least one limiting element is combined with the at least one positioning part.

### CROSS REFERENCE TO RELATED APPLICATIONS

The present application is based on, and claims priority from, China Patent Application No. 202422949335.X, filed Nov. 29, 2024, the disclosure of which is hereby incorporated by reference herein in its entirety.

### BACKGROUND OF THE INVENTION

### Field of the Invention

The present invention generally relates to a head-mounted display, and more particularly to a head-mounted display with a detachable face mask and an excellent assembly stability.

### Description of Related Art

Usually, head-mounted displays are human-computer interaction devices. The head-mounted displays may be used in application fields of Virtual Reality (VR), Augmented Reality (AR) and Mixed Reality (MR), etc. The head-mounted displays provide visual feedbacks and auditory feedbacks. Structurally, the head-mounted display generally includes a display device, a mask part and a headband. The display device is fixedly worn on a head of a user by the mask part and the headband. In order to provide a convenience for the user to clean or replace the head-mounted display, the mask part is often a detachable structure.

Virtual reality glasses with an eye mask includes a housing, a first eye mask and a second eye mask. The first eye mask is mounted to one side of the housing, and the second eye mask is detachably arranged to one side of the first eye mask. The first eye mask is located between the housing and the second eye mask. A periphery of the one side of the housing near the first eye mask is provided with a plurality of buckling slots and positioning grooves. The other side of the first eye mask near the housing is provided with a plurality of latching blocks and positioning blocks. The latching blocks of the first eye mask are combined with the buckling slots of the housing, and the positioning blocks of the first eye mask are combined with the positioning grooves of the housing, so that the first eye mask is fixedly mounted to the housing. The one side of the first eye mask near the second eye mask is provided with a plurality of first magnets, and one side of the second eye mask near the first eye mask is provided with a plurality of second magnets. A magnetic attraction between the first magnets of the first eye mask and the second magnets of the second eye mask makes that the first eye mask is assembled with or disassembled from the second eye mask more conveniently.

However, after the plurality of the first magnets and the second magnets in this structure design are used for a long-term use, an oxidation and corrosion phenomenon of the plurality of the first magnets and the second magnets are easily caused, the magnetic attraction is affected. Furthermore, because an additional limiting structure is lacked between the first eye mask and the second eye mask, when the first eye mask and the second eye mask are under actions of external forces, the first eye mask and the second eye mask are prone to fall from each other, and an assembly stability is affected.

In view of the above-mentioned shortcomings, it is necessary to provide a head-mounted display with a detachable mask and an excellent assembly stability.

### BRIEF SUMMARY OF THE INVENTION

An object of the present invention is to provide a head-mounted display with a detachable face mask and an excellent assembly stability. The head-mounted display includes a housing including a bracket, at least one elastic fastener, at least one positioning part, a face mask, at least one positioning elasticity piece and at least one limiting element. The bracket is assembled to a rear of the housing. The at least one elastic fastener has an elastic arm extended rearward from a rear surface of the bracket, and a holding part protruded outward from an outer surface of a free end of the elastic arm. The holding part has a fastening surface formed at a junction between the elastic arm and the holding part. The at least one positioning part is protruded frontward from a front surface of the bracket. The face mask is detachably assembled to a rear of the bracket, and the face mask is disposed to the rear of the housing. The at least one positioning elasticity piece is elastically deformable, and the at least one positioning elasticity piece is disposed on an inner side wall of the face mask. A free end of the at least one positioning elasticity piece has a buckling part. A front wall of the buckling part slantwise extends frontward and inward to form a buckling surface. The holding part and the buckling part are buckled with each other. The buckling surface is aligned with the fastening surface. The at least one limiting element is formed on a front surface of the face mask. The at least one limiting element is combined with the at least one positioning part.

Another object of the present invention is to provide a head-mounted display. The head-mounted display includes a casing, a bracket installed to a rear of the casing, two elastic fasteners, a plurality of positioning parts, a face mask, two elastically deformable positioning elasticity pieces and a plurality of limiting elements. The casing and the bracket together define an accommodating space between the casing and the bracket to accommodate a display module. The two elastic fasteners are protruded rearward from two sides of a rear surface of the bracket. Each elastic fastener has an elastic arm and a holding part. The two sides of the rear surface of the bracket extend rearward to form two elastic arms of the two elastic fasteners. The holding part is protruded outward from an outer surface of a rear end of the elastic arm. The holding part has a fastening surface slantwise extended rearward and outward from an outer surface of the rear end of the elastic arm. Several portions of a periphery of the bracket protrude frontward to form the plurality of the positioning parts. Each positioning part is hollow. A rear end of each positioning part opens freely. The face mask is detachably assembled to a rear of the bracket, and the face mask is disposed to the rear of the casing. Two inner side walls of the face mask are equipped with the two positioning elasticity pieces. A free end of each positioning elasticity piece has a buckling part. A front wall of the buckling part slantwise extends frontward and inward to form a buckling surface. The holding part and the buckling part are buckled with each other. The buckling surface and the fastening surface are attached to each other, and the two elastic fasteners are correspondingly combined with the two positioning elasticity pieces. Several portions of a front surface of the face mask protrude frontward to form the plurality of the limiting elements. The plurality of the limiting elements are inserted into the plurality of the positioning parts.

Another object of the present invention is to provide a head-mounted display. The head-mounted display includes a casing, a bracket, two elastic fasteners, a plurality of positioning parts, a face mask, two elastically deformable positioning elasticity pieces and a plurality of limiting elements. The bracket is installed to a rear of the casing. The casing and the bracket together define an accommodating space between the casing and the bracket to accommodate a display module. The two elastic fasteners are protruded rearward from two sides of a rear surface of the bracket. Each elastic fastener has an elastic arm and a holding part. The two sides of the rear surface of the bracket extend rearward to form two elastic arms of the two elastic fasteners. The holding part is protruded outward from an outer surface of a rear end of the elastic arm. The holding part has a fastening surface slantwise extended rearward and outward from an outer surface of the rear end of the elastic arm. Several portions of a periphery of the bracket protrude frontward to form the plurality of the positioning parts. A rear end of each positioning part opens freely. Each positioning part has a positioning hole recessed into an inside of the positioning part from the rear surface of the bracket. The face mask is detachably assembled to a rear of the bracket, and the face mask is disposed to the rear of the casing. Two inner side walls of the face mask are equipped with the two positioning elasticity pieces. A free end of each positioning elasticity piece has a buckling part. A front wall of the buckling part slantwise extends frontward and inward to form a buckling surface. The holding part and the buckling part are buckled with each other. The buckling surface is aligned with the fastening surface, and the two elastic fasteners are correspondingly combined with the two positioning elasticity pieces. Several portions of a front surface of the face mask protrude frontward to form the plurality of the limiting elements. The plurality of the limiting elements are combined in the positioning holes of the plurality of the positioning parts.

As described above, the head-mounted display includes the casing, the bracket installed to the rear of the casing, and the face mask that is detachably assembled to the rear of the bracket and disposed to the rear of the casing. The two sides of the rear surface of the bracket extend rearward and towards the face mask to form the two elastic arms of the two elastic fasteners, and the holding part is protruded outward from the outer surface of the free end of the elastic arm. The fastening surface is located at the junction between the elastic arm and the holding part, and the positioning hole is recessed into the inside of the positioning part from the rear surface of the bracket. Furthermore, the inner side wall of the face mask is equipped with the at least one elastically deformable positioning elasticity piece, the free end of the at least one positioning elasticity piece has the buckling part, the front wall of the buckling part slantwise extends frontward and inward to form the buckling surface, and the front surface of the face mask is equipped with the at least one limiting element, the holding parts of the two elastic fasteners are buckled with the two buckling parts of the two positioning elasticity pieces, the two buckling surfaces of the two positioning elasticity pieces are aligned with the two fastening surfaces of the two holding parts of the two elastic fasteners of the bracket, the at least one positioning part is aligned with the at least one limiting element, so the at least one limiting element is combined with the at least one positioning part to improve an assembly stability of the face mask. As a result, the head-mounted display with the detachable face mask and the excellent assembly stability.

### BRIEF DESCRIPTION OF THE DRAWINGS

The present invention will be apparent to those skilled in the art by reading the following description, with reference to the attached drawings, in which:

FIG. 1 is a perspective view of a head-mounted display in accordance with the present invention;

FIG. 2 is a partially exploded view of the head-mounted display in accordance with the present invention;

FIG. 3 is another partially exploded view of the head-mounted display in accordance with the present invention;

FIG. 4 is a partially sectional view of the head-mounted display along a line I-I of FIG. 1;

FIG. 5 is an enlarged view of an encircled portion A of the head-mounted display of FIG. 4;

FIG. 6 is a perspective view of a face mask of the head-mounted display in accordance with the present invention;

FIG. 7 is a perspective view of a bracket of the head-mounted display in accordance with the present invention;

FIG. 8 is a perspective view of a casing of the head-mounted display in accordance with the present invention; and

FIG. 9 is one more partially exploded view of the head-mounted display in accordance with the present invention.

### DETAILED DESCRIPTION OF THE INVENTION

In order to provide a detailed explanation of a technical content, structural features, achieved objectives and effects of the present invention, following embodiments are provided with accompanying diagrams to illustrate in detail.

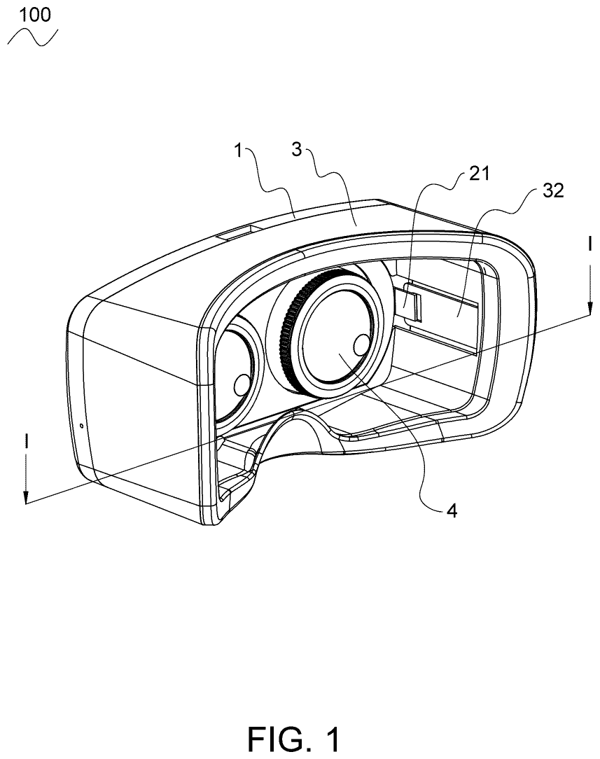

Referring to FIG. 1 to FIG. 3, a head-mounted display 100 in accordance with the present invention is shown. The head-mounted display 100 includes a housing 10, a display module 4 housed within the housing 10, and a face mask 3 detachably assembled to a rear of the housing 10. The housing 10 includes a casing 1 and a bracket 2. The bracket 2 is installed to a rear of the casing 1. The face mask 3 is assembled to the rear of the housing 10. The casing 1 and the bracket 2 together define an accommodating space 101 between the casing 1 and the bracket 2 to accommodate the display module 4. The face mask 3 is detachably assembled to a rear of the bracket 2, and the face mask 3 is disposed to the rear of the casing 1 of the housing 10.

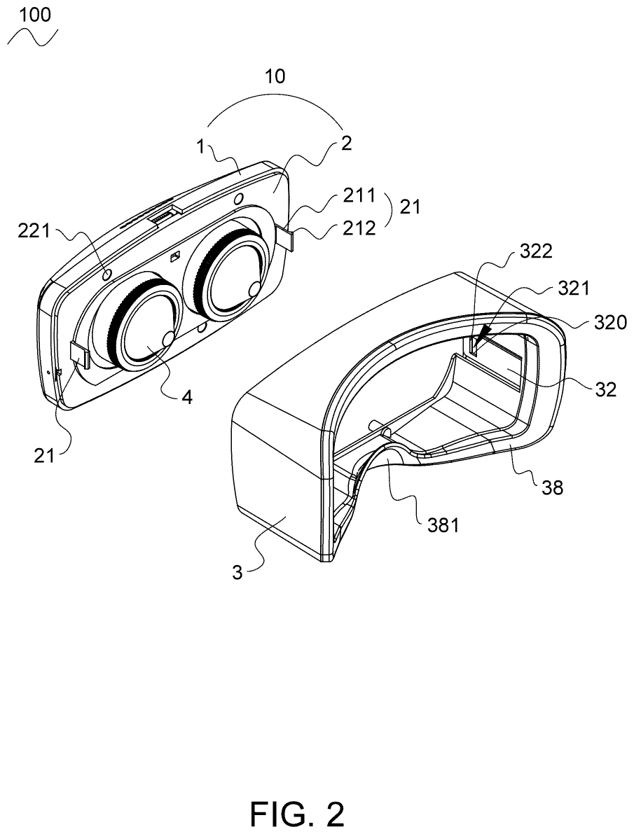

Referring to FIG. 2 to FIG. 6, in order to detachably assemble the face mask 3 to the rear of the housing 10, a rear surface of the bracket 2 is equipped with at least one elastic fastener 21, and at least one positioning part 22 protruded frontward from a front surface of the bracket 2. The at least one elastic fastener 21 is elastically deformable. An inner side wall of the face mask 3 is equipped with at least one elastically deformable positioning elasticity piece 32, and a front surface of the face mask 3 is equipped with at least one limiting element 33.

The face mask 3 has at least one opening slot 31. A rear wall of the at least one opening slot 31 extends frontward to form the at least one positioning elasticity piece 32. The at least one positioning elasticity piece 32 is disposed on the inner side wall of the face mask 3. The at least one limiting element 33 is formed on the front surface of the face mask 3. The at least one elastic fastener 21 is inserted into the face mask 3, and the at least one elastic fastener 21 is buckled with the at least one positioning elasticity piece 32. The at least one positioning part 22 is aligned with the at least one limiting element 33, and the at least one limiting element 33 is inserted into the at least one positioning part 22, so the at least one limiting element 33 is combined with the at least one positioning part 22, and the face mask 3 is mounted to the rear of the housing 10.

The rear surface of the bracket 2 is equipped with two elastic fasteners 21 protruded rearward from two sides of the rear surface of the bracket 2. Specifically, the two sides of the rear surface of the bracket 2 protrude rearward to form the two elastic fasteners 21. Several portions of a periphery of the bracket 2 protrude frontward to form a plurality of the positioning parts 22 arranged in an upper row and a lower row. Each positioning part 22 is hollow. A rear end of each positioning part 22 opens freely. The head-mounted display 100 includes two elastically deformable positioning elasticity pieces 32. Two inner side walls of the face mask 3 are equipped with the two positioning elasticity pieces 32, and front ends of the two positioning elasticity pieces 32 are free ends of the two positioning elasticity pieces 32. Several portions of the front surface of the face mask 3 protrude frontward to form a plurality of the limiting elements 33. The plurality of the limiting elements 33 are arranged in the upper row and the lower row. The two elastic fasteners 21 are inserted into the face mask 3, and the two elastic fasteners 21 are buckled with the two positioning elasticity pieces 32. The plurality of the positioning parts 22 are aligned with the plurality of the limiting elements 33, and the plurality of the limiting elements 33 are inserted into the plurality of the positioning parts 22, so the face mask 3 is mounted to the rear of the housing 10.

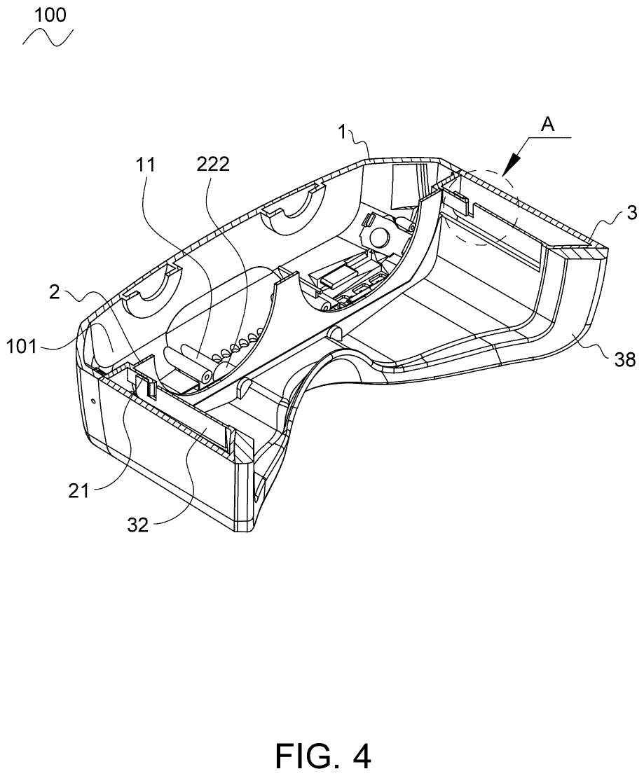

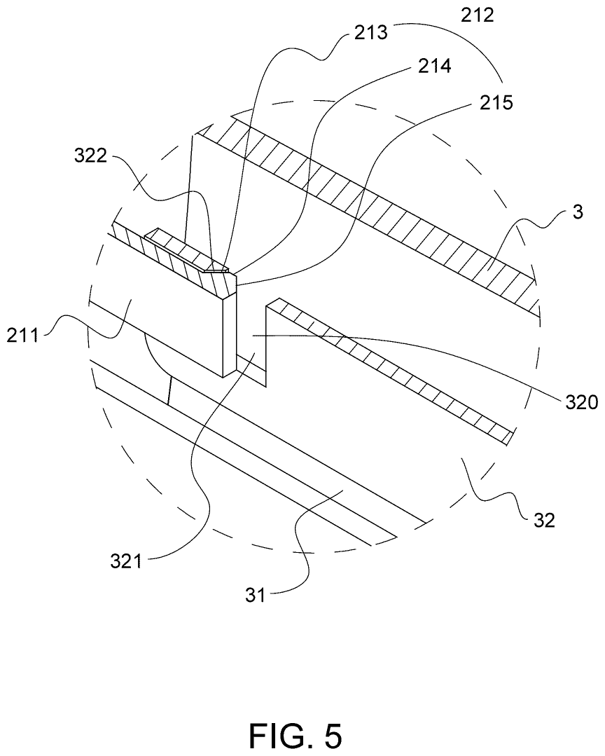

Referring to FIG. 2, FIG. 4 and FIG. 5, a quantity of the at least one elastic fastener 21 is set to two. The two elastic fasteners 21 are symmetrically arranged at two outer sides of the bracket 2. The two elastic fasteners 21 are symmetrically arranged at a left side and a right side of the bracket 2. Each elastic fastener 21 has an elastic arm 211 and a holding part 212. The at least one elastic fastener 21 has the elastic arm 211 extended rearward from the rear surface of the bracket 2, and the holding part 212. The two sides of the rear surface of the bracket 2 extend rearward and towards the face mask 3 to form the two elastic arms 211 of the two elastic fasteners 21. The holding part 212 is formed at a free end of the elastic arm 211. The holding part 212 is protruded outward from an outer surface of the free end of the elastic arm 211. The holding part 212 is protruded outward from an outer surface of a rear end of the elastic arm 211.

Referring to FIG. 2 to FIG. 5, a cross-sectional shape of the holding part 212 is generally trapezoidal. The holding part 212 has a fastening surface 213, a connecting surface 214 and a guiding surface 215. The fastening surface 213 is formed at a junction between the elastic arm 211 and the holding part 212. The connecting surface 214 is arranged between the fastening surface 213 and the guiding surface 215, and the guiding surface 215 is located at a rear end of the holding part 212. The fastening surface 213 is slantwise extended rearward and outward from an outer surface of the rear end of the elastic arm 211. The fastening surface 213 faces the bracket 2. A thickness of a front end of the holding part 212 gradually increases from front to rear. The connecting surface 214 is horizontally extended rearward from a rear end of the fastening surface 213. The guiding surface 215 is slantwise extended rearward and inward from a rear end of the connecting surface 214. The guiding surface 215 faces the face mask 3. A thickness of the rear end of the holding part 212 gradually decreases from front to rear.

Referring to FIG. 2, FIG. 4 and FIG. 5, the face mask 3 includes the at least one opening slot 31 recessed into at least one side wall of the face mask 3. The at least one opening slot 31 penetrates through the front surface of the face mask 3. The at least one positioning elasticity piece 32 is received in the at least one opening slot 31. A quantity of the at least one opening slot 31 is set to two. Two middles of the two inner side walls of the face mask 3 are recessed oppositely to form the two opening slots 31 penetrating through the front surface of the face mask 3. A quantity of the at least one positioning elasticity pieces 32 is set to two. Two rear walls of the two opening slots 31 extend frontward to form the two positioning elasticity pieces 32. The free ends of the two positioning elasticity pieces 32 are able to be elastically deformed inward or outward within the two opening slots 31.

The free end of the at least one positioning elasticity piece 32 has a buckling part 321. The free end of each positioning elasticity piece 32 has the buckling part 321. The holding part 212 and the buckling part 321 are buckled with each other. The holding parts 212 of the two elastic fasteners 21 are buckled with the two buckling parts 321 of the two positioning elasticity pieces 32. A front wall of the buckling part 321 slantwise extends frontward and inward to form a buckling surface 322. The buckling surface 322 is aligned with the fastening surface 213, and the two elastic fasteners 21 are correspondingly combined with the two positioning elasticity pieces 32.

Preferably, the free end of the at least one positioning elasticity piece 32 has a buckling hole 320 transversely penetrating through the at least one positioning elasticity piece 32. The free end of each positioning elasticity piece 32 has the buckling hole 320 transversely penetrating through the positioning elasticity piece 32. The buckling part 321 is the buckling hole 320. The holding parts 212 of the two elastic fasteners 21 are buckled in the two buckling holes 320 of the two positioning elasticity pieces 32. A front wall of the buckling hole 320 slantwise extends frontward and inward to form the buckling surface 322. The buckling surface 322 is matched with the fastening surface 213. The buckling surface 322 and the fastening surface 213 are attached to each other, so that the two elastic fasteners 21 are correspondingly combined with the two positioning elasticity pieces 32.

Referring to FIG. 2 to FIG. 6, in order to smoothly assemble the face mask 3 to the bracket 2, the free ends of the two positioning elasticity pieces 32 push against the two guiding surfaces 215 of the two holding parts 212 of the two elastic fasteners 21 of the bracket 2 along an assembly direction. The two guiding surfaces 215 reduce resistance forces during an assembly of the head-mounted display 100, at the moment, the two positioning elasticity pieces 32 are elastically deformed outward, and the two elastic fasteners 21 are elastically deformed inward, so that the free ends of the two positioning elasticity pieces 32 are unaffected by a sliding interference to pass over the two holding parts 212, and the two holding parts 212 are buckled to the two buckling parts 321 of the two positioning elasticity pieces 32. After the two positioning elasticity pieces 32 and the two elastic fasteners 21 rebound to original positions, the two buckling surfaces 322 of the two positioning elasticity pieces 32 are aligned with the two fastening surfaces 213 of the two holding parts 212 of the two elastic fasteners 21 of the bracket 2, so each elastic fastener 21 is limited to one positioning elasticity piece 32, and each positioning elasticity piece 32 is limited to one elastic fastener 21. When a user removes the face mask 3, the two buckling surfaces 322 push against the two fastening surfaces 213 along a disassembly direction, so that the two holding parts 212 are pushed out of the two buckling parts 321.

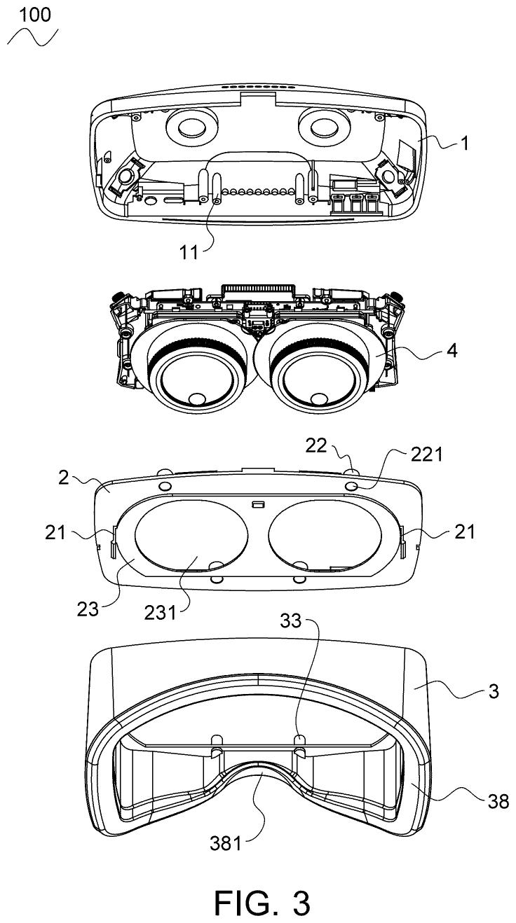

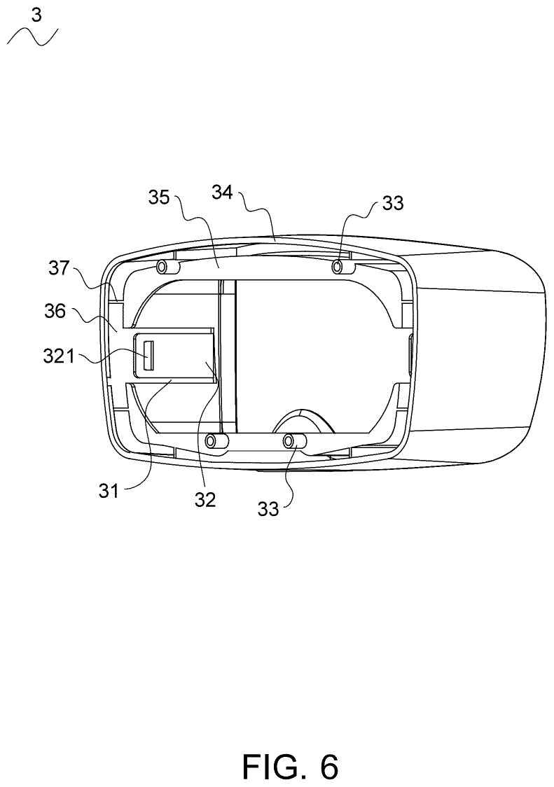

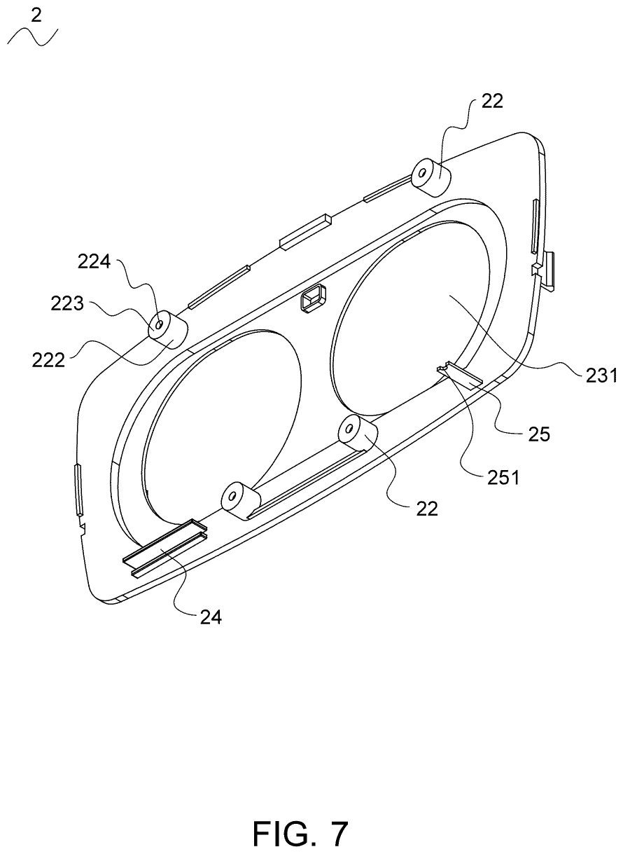

Referring to FIG. 3, FIG. 6 and FIG. 7, the at least one positioning part 22 has a positioning hole 221 recessed into an inside of the at least one positioning part 22 from the rear surface of the bracket 2. The at least one limiting element 33 is configured as a protruding column structure. The at least one limiting element 33 is extended forward from the front surface of the face mask 3. The at least one limiting element 33 is aligned with the positioning hole 221 of the at least one positioning part 22, and the at least one limiting element 33 is combined in the positioning hole 221 of the at least one positioning part 22, so that a location and a fixation between the bracket 2 and the face mask 3 are realized.

Each positioning part 22 is hollow. Each positioning part 22 has the positioning hole 221. The positioning hole 221 is recessed into the inside of the positioning part 22 from the rear surface of the bracket 2. Each limiting element 33 is configured as the protruding column structure, and each limiting element 33 is extended forward from the front surface of the face mask 3. The plurality of the limiting elements 33 are aligned with the positioning holes 221 of the plurality of the positioning parts 22, and the plurality of the limiting elements 33 are combined in the positioning holes 221 of the plurality of the positioning parts 22.

Preferably, the front surface of the face mask 3 has four limiting elements 33. Two limiting elements 33 are arranged in the upper row of the limiting elements 33, and the other two limiting elements 33 are arranged in the lower row of the limiting elements 33. A spacing between the two limiting elements 33 in the upper row is greater than a spacing between the other two limiting elements 33 in the lower row. The bracket 2 has four positioning parts 22. The four positioning parts 22 are aligned with the four limiting elements 33. The four positioning parts 22 are combined with the four limiting elements 33. The upper row of the limiting elements 33 and the lower row of the limiting elements 33 of the face mask 3 are arranged asymmetrically. The four positioning parts 22 are aligned with the upper row of the limiting elements 33 and the lower row of the limiting elements 33, and the four positioning parts 22 are combined with the upper row of the limiting elements 33 and the lower row of the limiting elements 33, so when the face mask 3 is assembled to the bracket 2, the face mask 3 and the bracket 2 are prevented from being assembled in wrong directions.

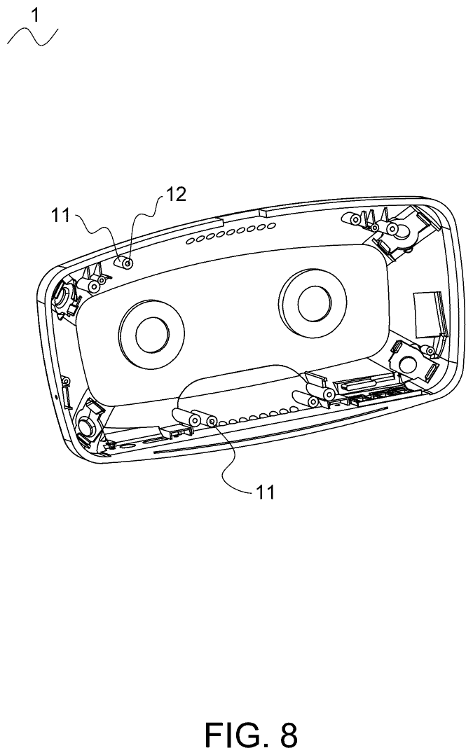

Referring to FIG. 4, FIG. 7 and FIG. 8, in order to fix the bracket 2 to the casing 1, the at least one positioning part 22 has a positioning post 222, a blocking wall 223 and a locking hole 224. Each positioning part 22 includes the positioning post 222, the blocking wall 223 and the locking hole 224. The positioning post 222 is extended forward from the front surface of the bracket 2. The blocking wall 223 is formed at a front end of the positioning post 222. The positioning hole 221 is recessed into an interior of the positioning post 222 from the rear surface of the bracket 2. A middle of the positioning hole 221 extends frontward to form the locking hole 224 longitudinally penetrating through a front surface of the blocking wall 223. The locking hole 224 penetrates through a front surface of the positioning post 222. A diameter of the locking hole 224 is smaller than a diameter of the positioning hole 221. An inner surface of the casing 1 extends rearward to form at least one fixing post 11. An inner surface of the casing 1 of the housing 10 extends rearward to form the at least one fixing post 11. The at least one fixing post 11 is aligned with the positioning post 222 of the at least one positioning part 22. A rear surface of the at least one fixing post 11 is recessed inward to form a blind hole 12.

Preferably, an upper portion and a lower portion of the inner surface of the casing 1 have four fixing posts 11. The four fixing posts 11 are aligned with the four positioning posts 222 of the four positioning parts 22. A rear surface of each fixing post 11 is recessed inward to form the blind hole 12. A diameter of the blind hole 12 is smaller than the diameter of the locking hole 224. The blind hole 12 is aligned with the locking hole 224. A rear wall of the at least one fixing post 11 abuts against the blocking wall 223 of the at least one positioning part 22. The rear wall of each fixing post 11 abuts against the blocking wall 223 of one positioning part 22. The head-mounted display 100 further includes a locking element (not shown). The locking element (not shown) is locked forward into the blind hole 12 through the locking hole 224, so that a location between the casing 1 and the bracket 2 of the housing 10 and a fixation between the casing 1 and the bracket 2 are realized.

Referring to FIG. 6, the face mask 3 includes an outer frame part 34, an inner frame part 35, a hollow part 36 and at least one reinforcing rib 37. The outer frame part 34 is formed at an outer periphery of the face mask 3. The inner frame part 35 is formed at an inner periphery of the face mask 3. An outer surface of the inner frame part 35 is spaced from an inner surface of the outer frame part 34 to form the hollow part 36 between the outer frame part 34 and the inner frame part 35. The hollow part 36 reduces an overall weight of the face mask 3. The at least one reinforcing rib 37 is arranged in the hollow part 36. The at least one reinforcing rib 37 is connected between the inner surface of the outer frame part 34 and the outer surface of the inner frame part 35 to enhance a structural strength of the face mask 3. At least one side wall of the inner frame part 35 opens the at least one opening slot 31 communicated with the hollow part 36. The two opening slots 31 are opened at two side walls of the inner frame part 35. The two opening slots 31 are opened at a left side wall and a right side wall of the inner frame part 35. The two opening slots 31 are communicated with the hollow part 36. The at least one limiting element 33 is extended forward from a front surface of the inner frame part 35.

Referring to FIG. 2 and FIG. 3, the face mask 3 is configured to cover two eyes of the user. A rear of the face mask 3 has a face pad 38. The face pad 38 is disposed close to a face of the user. The face pad 38 is configured as a gasket structure, and the face pad 38 is attached to the face of the user. The face pad 38 is made of soft materials. The face pad 38 is made of a silicone material, a rubber material, a foam material or other soft materials. A middle of a bottom edge of the face pad 38 is recessed inward to form a nose pad 381. The nose pad 381 abuts against a nose of the user. The face pad 38 and the nose pad 381 are designed to fit a facial contour of the user, so the users replace the face masks 3 with different specifications according to preferences and face shapes of the users, so that a wearing of the face mask 3 fits more ergonomics and improves a wearing comfort degree. Additionally, the face mask 3 has advantages of disassembling and cleaning the face mask 3 easily, so the face mask 3 maintains hygiene and cleanliness.

Referring to FIG. 3, a middle of the rear surface of the bracket 2 extends rearward to form a base 23. The base 23 is corresponding to the inner frame part 35, and the base 23 is housed within the inner frame part 35. The at least one elastic fastener 21 is disposed to at least one outer side of the base 23. The two elastic fasteners 21 are arranged to two outer sides of the base 23. The two elastic fasteners 21 are disposed to a left side and a right side of the base 23. The base 23 defines a pair of opening holes 231 penetrating through the front surface and the rear surface of the bracket 2. The pair of the opening holes 231 are configured to accommodate the display module 4. The display module 4 is disposed in the pair of the opening holes 231.

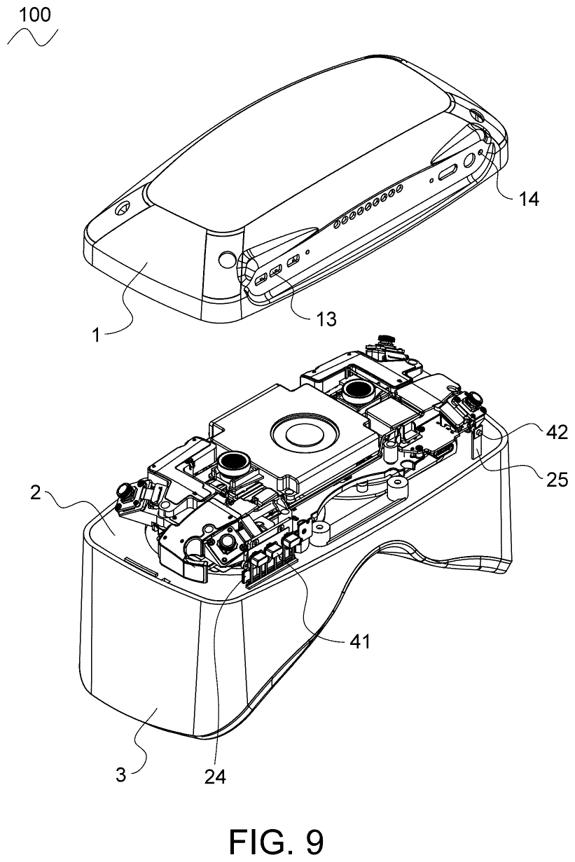

Referring to FIG. 7 and FIG. 9, the display module 4 includes a button structure 41 and a light-emitting unit 42. The bracket 2 includes a first strengthening rib 24 and a second strengthening rib 25. The first strengthening rib 24 and the second strengthening rib 25 are respectively arranged at two opposite sides of the front surface of the bracket 2. The first strengthening rib 24 is extended forward from one side of the front surface of the bracket 2, and the first strengthening rib 24 supports an upper portion of the button structure 41, so after the button structure 41 is pressed for a long time, the button structure 41 is prevented from shifting. The second strengthening rib 25 is extended forward from the other side of the front surface of the bracket 2. A middle of a front end of the second strengthening rib 25 is recessed inward to form an inwardly recessed semicircular groove 251 to fix the light-emitting unit 42. Two sides of a rear of the casing 1 of the housing 10 define a button hole 13 and a light hole 14 longitudinally penetrating through the rear of the casing 1, respectively. The button structure 41 is correspondingly arranged in the button hole 13, and the light-emitting unit 42 is correspondingly arranged in the light hole 14.

As described above, the head-mounted display 100 includes the casing 1, the bracket 2 installed to the rear of the casing 1, and the face mask 3 that is detachably assembled to the rear of the bracket 2 and disposed to the rear of the casing 1. The two sides of the rear surface of the bracket 2 extend rearward and towards the face mask 3 to form the two elastic arms 211 of the two elastic fasteners 21, and the holding part 212 is protruded outward from the outer surface of the free end of the elastic arm 211. The fastening surface 213 is located at the junction between the elastic arm 211 and the holding part 212, and the positioning hole 221 is recessed into the inside of the positioning part 22 from the rear surface of the bracket 2. Furthermore, the inner side wall of the face mask 3 is equipped with the at least one elastically deformable positioning elasticity piece 32, the free end of the at least one positioning elasticity piece 32 has the buckling part 321, the front wall of the buckling part 321 slantwise extends frontward and inward to form the buckling surface 322, and the front surface of the face mask 3 is equipped with the at least one limiting element 33, the holding parts 212 of the two elastic fasteners 21 are buckled with the two buckling parts 321 of the two positioning elasticity pieces 32, the two buckling surfaces 322 of the two positioning elasticity pieces 32 are aligned with the two fastening surfaces 213 of the two holding parts 212 of the two elastic fasteners 21 of the bracket 2, the at least one positioning part 22 is aligned with the at least one limiting element 33, so the at least one limiting element 33 is combined with the at least one positioning part 22 to improve an assembly stability of the face mask 3. As a result, the head-mounted display 100 with the detachable face mask 3 and the excellent assembly stability.

What is claimed is:

1. A head-mounted display, comprising:
a housing having a bracket, the bracket being assembled to a rear of the housing;
at least one elastic fastener having an elastic arm extended rearward from a rear surface of the bracket, and a holding part protruded outward from an outer surface of a free end of the elastic arm, the holding part having a fastening surface formed at a junction between the elastic arm and the holding part;
at least one positioning part being formed on the bracket;
a face mask detachably assembled to a rear of the bracket, and the face mask being disposed to the rear of the housing;
at least one positioning elasticity piece being elastically deformable, and the at least one positioning elasticity piece being disposed on an inner side wall of the face mask, a free end of the at least one positioning elasticity piece having a buckling part, a front wall of the buckling part slantwise extending frontward and inward to form a buckling surface, the holding part and the buckling part being buckled with each other, the buckling surface being engaged with the fastening surface; and
at least one limiting element formed on a front surface of the face mask, the at least one limiting element being combined with the at least one positioning part.

2. The head-mounted display as claimed in claim 1, wherein the holding part has a guiding surface located at a rear end of the holding part, and a connecting surface arranged between the fastening surface and the guiding surface, the fastening surface is slantwise extended rearward and outward from an outer surface of a rear end of the elastic arm, the fastening surface faces the bracket, a thickness of a front end of the holding part gradually increases from front to rear, the connecting surface is horizontally extended rearward from a rear end of the fastening surface, the guiding surface is slantwise extended rearward and inward from a rear end of the connecting surface, the guiding surface faces the face mask, a thickness of the rear end of the holding part gradually decreases from front to rear.

3. The head-mounted display as claimed in claim 1, wherein the face mask has at least one opening slot recessed into at least one side wall of the face mask, the at least one opening slot penetrates through the front surface of the face mask, a rear wall of the at least one opening slot extends frontward to form the at least one positioning elasticity piece, the at least one positioning elasticity piece is received in the at least one opening slot.

4. The head-mounted display as claimed in claim 1, wherein the free end of the at least one positioning elasticity piece has a buckling hole transversely penetrating through the at least one positioning elasticity piece, the buckling part is the buckling hole.

5. The head-mounted display as claimed in claim 1, wherein the at least one positioning part is protruded frontward from a front surface of the bracket, the at least one positioning part has a positioning hole recessed into an inside of the at least one positioning part from the rear surface of the bracket, the at least one limiting element is configured as a protruding column structure, the at least one limiting element is extended forward from the front surface of the face mask, the at least one limiting element is aligned with the positioning hole of the at least one positioning part, and the at least one limiting element is combined in the positioning hole of the at least one positioning part.

6. The head-mounted display as claimed in claim 5, wherein the at least one positioning part has a positioning post extended forward from the front surface of the bracket, and a locking hole, a middle of the positioning hole extends frontward to form the locking hole penetrating through a front surface of the positioning post, the housing has a casing, an inner surface of the casing extends rearward to form at least one fixing post, the at least one fixing post is aligned with the positioning post of the at least one positioning part, a rear surface of the at least one fixing post is recessed inward to form a blind hole, the blind hole is aligned with the locking hole.

7. The head-mounted display as claimed in claim 1, wherein the face mask has an outer frame part, an inner frame part, a hollow part and at least one reinforcing rib, the outer frame part is formed at an outer periphery of the face mask, the inner frame part is formed at an inner periphery of the face mask, an outer surface of the inner frame part is spaced from an inner surface of the outer frame part to form the hollow part between the outer frame part and the inner frame part, the at least one reinforcing rib is arranged in the hollow part, the at least one reinforcing rib is connected between the inner surface of the outer frame part and the outer surface of the inner frame part, at least one side wall of the inner frame part opens at least one opening slot communicated with the hollow part, the at least one positioning elasticity piece is received in the at least one opening slot, a rear wall of the at least one opening slot extends frontward to form the at least one positioning elasticity piece, the at least one limiting element is extended forward from a front surface of the inner frame part.

8. The head-mounted display as claimed in claim 7, wherein the housing has a casing, the bracket is installed to a rear of the casing, the casing and the bracket together define an accommodating space between the casing and the bracket to accommodate a display module, a middle of the rear surface of the bracket extends rearward to form a base, the base is corresponding to the inner frame part, and the base is housed within the inner frame part, the at least one elastic fastener is disposed to at least one outer side of the base, the base defines a pair of opening holes penetrating through the front surface and the rear surface of the bracket, the display module is disposed in the pair of the opening holes.

9. The head-mounted display as claimed in claim 8, wherein the display module has a button structure and a light-emitting unit, the bracket has a first strengthening rib extended forward from one side of the front surface of the bracket, and a second strengthening rib extended forward from the other side of the front surface of the bracket, the first strengthening rib supports an upper portion of the button structure, a middle of a front end of the second strengthening rib is recessed inward to form a semicircular groove to fix the light-emitting unit, two sides of a rear of the casing of the housing define a button hole and a light hole longitudinally penetrating through the rear of the casing, respectively, the button structure is correspondingly arranged in the button hole, and the light-emitting unit is correspondingly arranged in the light hole.

10. The head-mounted display as claimed in claim 1, wherein a rear of the face mask has a face pad.

11. The head-mounted display as claimed in claim 10, wherein the face pad is made of soft materials.

12. The head-mounted display as claimed in claim 10, wherein a middle of a bottom edge of the face pad is recessed inward to form a nose pad.

13. A head-mounted display, comprising:
a casing having a plurality of fixing posts;
a bracket installed to a rear of the casing, the casing and the bracket together defining an accommodating space between the casing and the bracket to accommodate a display module;
two elastic fasteners protruded rearward from two sides of a rear surface of the bracket, each elastic fastener having an elastic arm and a holding part, the two sides of the rear surface of the bracket extending rearward to form two elastic arms of the two elastic fasteners, the holding part being protruded outward from an outer surface of a rear end of the elastic arm, the holding part having a fastening surface slantwise extended rearward and outward from an outer surface of the rear end of the elastic arm;
a plurality of positioning parts, several portions of a periphery of the bracket protruding frontward to form the plurality of the positioning parts, each positioning part being hollow, a rear end of each positioning part opening freely, the plurality of the positioning parts assembled to the plurality of the fixing posts;
a face mask detachably assembled to a rear of the bracket, and the face mask being disposed to the rear of the casing;
two elastically deformable positioning elasticity pieces, two inner side walls of the face mask being equipped with the two positioning elasticity pieces, a free end of each positioning elasticity piece having a buckling part, a front wall of the buckling part slantwise extending frontward and inward to form a buckling surface, the holding part and the buckling part being buckled with each other, the buckling surface and the fastening surface being attached to each other, and the two elastic fasteners being correspondingly combined with the two positioning elasticity pieces; and
a plurality of limiting elements, several portions of a front surface of the face mask protruding frontward to form the plurality of the limiting elements, the plurality of the limiting elements being inserted into the plurality of the positioning parts.

14. A head-mounted display, comprising:
a casing;
a bracket assembled to a rear of the casing, the casing and the bracket together defining an accommodating space between the casing and the bracket to accommodate a display module;
at least two elastic fasteners protruded rearward from two sides of the bracket, each the elastic fastener having an elastic arm and a holding part, the two sides of the bracket extending rearward to form two elastic arms of the two elastic fasteners, the holding part being protruded outward from a rear end of the elastic arm, the holding part having a fastening surface slantwise extended rearward and outward from an outer surface of the rear end of the elastic arm;
a face mask detachably assembled to a rear of the bracket, and the face mask being disposed to the rear of the casing, the face mask having an outer frame part, an inner frame part and a hollow part, the outer frame part being formed at an outer periphery of the face mask, the inner frame part being formed at an inner periphery of the face mask, the inner frame part is spaced from the outer frame part to form the hollow part between the outer frame part and the inner frame part, two sides of the inner frame part having at least two opening slot communicated with the hollow part; and
at least two elastically deformable positioning elasticity pieces extended from the inner frame part and positioned in the opening slots, a free end of each the positioning elasticity piece having a buckling part, a front wall of the buckling part slantwise extending frontward and inward to form a buckling surface, the holding part and the buckling part being buckled with each other, the buckling surface being engaged with the fastening surface, and the two elastic fasteners being correspondingly combined with the two positioning elasticity pieces.
